(19) United States
(12) Patent Application Publication
(10) Pub. No.: US 2022/0230241 A1
(43) Pub. Date: Jul. 21, 2022

(54) NETWORKED SYSTEM FOR TRADER MANAGEMENT AND METHODS OF USE THEREOF

(71) Applicant: Wells Fargo Bank, N.A., San Francisco, CA (US)

(72) Inventors: Pravin Annaso Chougule, Fort Mill, SC (US); Darren Michael Muller, Ridgefield, CT (US); Krupakar Pasupuleti, San Francisco, CA (US)

(21) Appl. No.: 15/671,707

(22) Filed: Aug. 8, 2017

(51) Int. Cl. G06Q 40/04; H04L 29/06

(52) U.S. Cl. CPC G06Q 40/04; H04L 63/0861

(57) ABSTRACT

Various examples are directed to systems and methods for providing a user interface to a trader. A trader user interface (UI) system may receive entertainment history data from an entertainment system of the trader and appliance history data from a first appliance of the trader. The trader UI system may extract first security reference data from the entertainment history data and second security reference data from the appliance history data. The trader UI system may select first content for the trader user interface based at least in part on the first security reference data and second content for the trader user interface based at least in part on the second security reference data.

### TECHNICAL FIELD

Embodiments described herein generally relate to networked methods and systems for managing traders.

### BACKGROUND

Trading in securities is a demanding activity that can tax a trader's intellect, discipline, and stamina. Accordingly, there is a need for technological tools for assisting and managing traders.

### DRAWINGS

In the drawings, which are not necessarily drawn to scale, like numerals may describe similar components in different views. Like numerals having different letter suffixes may represent different instances of similar components. Some embodiments are illustrated by way of example, and not of limitation, in the figures of the accompanying drawings.

FIG. 1 is a diagram showing one example of an environment for providing a trader user interface (UI) to a trader.

FIG. 2 is a diagram showing one example of an environment for distributing trade requests to traders based on feedback.

FIG. 3 is a diagram showing another example environment including components of the environment of FIG. 1 and the environment of FIG. 2.

FIG. 4 is a flowchart showing one example of a process flow that may be executed, for example, by the trader Iii system of FIG. 1 to generate and serve a trader UI to a trader.

FIG. 5 is a flowchart showing one example of a process flow that may be executed, for example, by the trader system of FIG. 1 to extract security reference data from network-enabled device history data.

FIG. 6 is a timeline showing an example correlation of biometric anomalies and other network-enabled device history data.

FIG. 7 is a flowchart showing one example of a process flow that may be executed, for example, by the request distribution system of FIG. 2 to assign trade requests to traders.

FIG. 8 is a flowchart showing one example of a process flow that may be executed by the request distribution system of FIG. 2 to distribute trade requests to traders.

FIG. 9 is a block diagram showing an example architecture of a user computing device.

FIG. 10 is a block diagram showing one example of a software architecture for a computing device.

FIG. 11 is a block diagram illustrating a computing device hardware architecture, within which a set or sequence of instructions can be executed to cause a machine to perform examples of any one of the methodologies discussed herein.

### DETAILED DESCRIPTION

A trader UI system provides a trader UI to a securities trader at a trader device including one or more displays. The trader UI provides the trader with information for selecting and/or executing trades in securities. The trader UI provides the trader with various information related to securities trading, such as, for example, current market conditions, current events related to securities in general and/or a particular security, etc.

In many circumstances, it is important for a trader to quickly access information about a particular market or security. For example, when there are delays in providing information to a trader, it can lead to delays in trade selection and execution. Delayed trades may be less likely to be profitable, especially in fast-moving markets.

Existing tools for providing information to traders can require a high degree of mental acuity. For example, a trader considering a trade may want to view data about a particular security, market, country, etc. related to the trade. To access the appropriate data, the trader must remember the correct identifying data. For example, it is often not enough for the trader to remember that she read a news story about a particular company last Tuesday unless the trader also remembers the name of the company, the name of the publication including the news story, etc.

Various examples described herein include a trader UI system that is in communication with one or more network-enabled devices of the trader, Network-enabled devices may include devices that the trader uses at work or at home, such as, for example, user computing devices (e.g., for web browsing), appliances, biometric sensor devices, entertainment systems, security systems, etc. Network-enabled devices, in some examples, include Internet of Things (IoT) devices, Network-enabled devices may provide history data to the trader UI describing the history of the trader's use of the various network-enabled devices. The trader UI system receives the history data and extracts security reference data that is related to or descriptive of a security or market. In some examples, the security reference data is tagged or indexed, for example, based on the network-enabled device that provided it, the time at which the corresponding history data was created, etc.

The trader UI system may select content to be provided to the trader at a trader UI based at least in part on the extracted security reference data. For example, if the trader requests or is otherwise to receive data about a particular security, the trader UI system may provide the security reference data in addition to data that would have otherwise been provided. Also, in some examples, the trader UI system may use the security reference data to allow the trader to more quickly and accurately select security information to be received at the trader UI. For example, the trader may remember security or market data that the trader would like to view, but may not remember the name of the security or market. The trader may access the information, for example, by referencing a tag or index topic used to tag or index the security reference data. The trader UI system may identify the security using the tag or index topic and may display information about the security (e.g., the security reference data and/or other data from other sources).

Some examples also include a request distribution system. The request distribution system is configured to distribute trade requests to traders. Trade requests may be requests to execute a trade for a security or securities. A trade request may specify the security or securities to be bought and/or sold. Upon receiving a trade request, a trader may execute the trade, for example, by entering one or more appropriate trade orders, determining one or more appropriate hedges, etc.

The performance of a trader can vary over time depending on the trader's mood, stress level, sleep level, and/or other factors. The request distribution system is in communication with one or more trade tracking systems and one or more biometric sensor devices. The trade tracking systems may track the success or failure of trades made by different traders (e.g., indicated by profit or loss). The biometric sensor devices may be positioned to sense biometric parameters of a trader, such as, for example, heart rate, temperature, physical activity, etc. The request distribution system distributes trade requests to traders considering trader criteria data that describes the type of trade requests that the trader is to receive and execute. The request distribution system monitors a trader's biometric data and the trader's trade result data (e.g., the profit or loss on trades executed by the trader). In some examples, the request distribution system also monitors the trader's data received from network-enabled devices. Based on the biometric data, the trade result data, and/or data from network-enabled devices, the request distribution system may detect a trader risk condition. A trader risk condition may indicate that the trader may be impaired (e.g., not at peak physical and mental condition).

In response to the trader risk condition, the request distribution system initiates a remedial action, for example, by modifying the trader criteria data to change the trade requests being sent to the trader. For example, a trader who has just suffered a large loss and is experiencing a very high heart rate may have his or her associated trader criteria modified to, for example, pause the trader's trading activity for a time, send the trader trade requests that are easier to execute, etc.

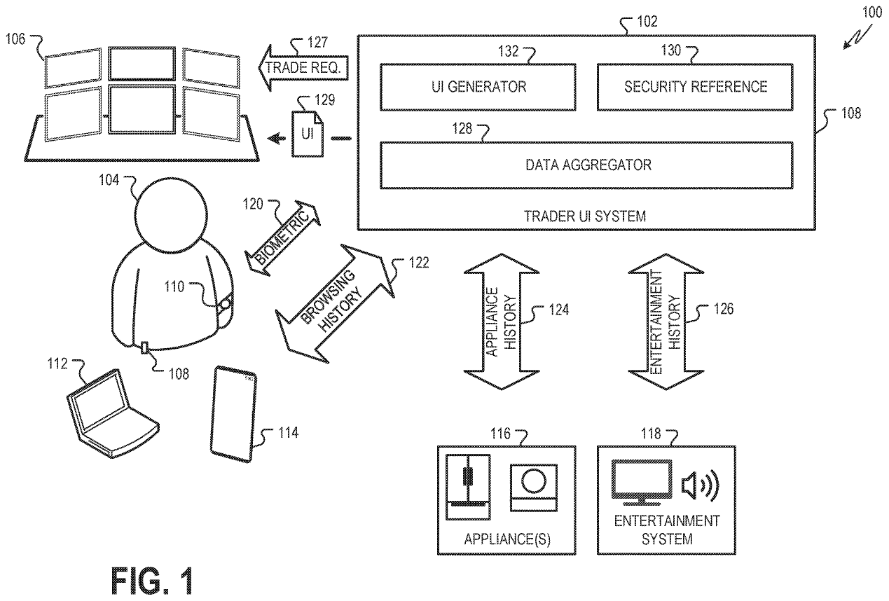

FIG. 1 is a diagram showing one example of an environment 100 for providing a trader UI 129 to a trader 104. The environment 100 includes a trader UI system 102 that provides the trader UI 129 to the trader 104 via a trader computing device 106. The trader UI system 102 receives history data from several example network devices, including biometric history data 120 from biometric sensor devices 108, 110, browsing history data 122 from a user computing device 114 or a user computing device 112, appliance history data 124 from one or more network-enabled appliances 116, and entertainment history data 126 from a network-enabled entertainment system 118.

The trader UI system 102 may be or include any suitable type of computing device, including, for example, a server, a laptop computer, a desktop computer, etc. The trader UI system 102 may be located at a single location or may include multiple networked computing devices spread across multiple geographic locations. The trader UI system 102 provides the trader UI 129 to the trader computing device 106. The trader computing device 106 may be or include any suitable device or devices such as, for example, a desktop computer, a laptop computer, a server, etc. The trader computing device 106 may also include input/output (I/O) devices such as, for example, multiple display screens for displaying the trader UI 129.

Several examples of network-enabled devices are provided in FIG. 1, including, for example, the biometric sensor devices 108, 110, the user computing devices 112, 114, the network-enabled appliances 116, and the network-enabled entertainment system 118. The user computing devices 112, 114 may be or include any suitable computing device used by the trader 104 for work and/or personal purposes. For example, the user computing devices 112, 114 may be or include a laptop computer, a desktop computer, a tablet computer, a smart phone, etc.

The biometric sensor devices 108, 110 sense biometric (e.g., physiological) properties of the trader 104. The biometric sensor devices 108, 110 may be or include wearables or any other device that includes a biometric sensor and is network-enabled. Examples of biometric sensor devices 108, 110 include, for example, watches, devices clipped to a belt or other location of the trader 104, etc. The biometric sensor devices 108, 110 may include one or more sensors such as, for example, accelerometers, gyroscopic sensors, etc. that sense movement of the trader 104. These sensors may be input devices configured to sense steps, altitude changes, etc. of the trader 104, which may indicate the trader's 104 level of physical activity. The biometric sensor devices 108, 110 may also include microphones, pressure sensors, electrodes, etc. for measuring the trader's 104 heart rate, breathing rate, blood pressure, and/or other physiological conditions.

The network-enabled appliances 116 may include any suitable home appliance that is network-enabled. For example, the network-enabled appliances 116 may include a network-enabled refrigerator. The refrigerator may include one or more input devices, such as a thermostat for measuring the temperature of the refrigerator, a thermostat for measuring the temperature of a freezer included with the refrigerator, a door latch sensor for the refrigerator and/or freezer to measure instances where the respective doors open, a camera, etc. For example, the camera may capture images of things in the refrigerator, images of things being put into the refrigerator, images of things being taken out of the refrigerator, etc. The refrigerator may also include one or more output devices such as, for example, a light inside the refrigerator or associated freezer, a display on an exterior or interior panel of the refrigerator, one or more exterior lights, a speaker, etc.

Another example of a network-enabled appliance 116 is a washer for clothes. The washer may include input devices such as a counter for counting the number of cycles executed by the washer, a door latch sensor for sensing when the machine is open or closed, a temperature gauge for measuring the temperature of water used in the washer, a detergent presence sensor for sensing the presence of and/or amount of detergent used in the washer, etc. The washer may include output devices such as, for example, a display, one or more exterior lights, a speaker, etc. Other examples of network-enabled appliances 116 may include microwave ovens, toasters, stand-alone freezers, hot water heaters, mixers, coffee makers, etc.

The network-enabled entertainment systems 118 may include one or more televisions or other displays, speakers, audio/video receivers, video disk players, etc. In some examples, a television, speakers, and other components may be aggregated into a single network-enabled entertainment system 118. In some examples, an individual television, audio receiver, etc. may act as a network-enabled entertainment system 118.

Although several example network-enabled devices are shown in FIG. 1, any other type of network-enabled device may be included. Other examples of network-enabled devices include a network-enabled security system, thermostat, etc. Also, for example, some network-enabled devices may have the capability to communicate directly with the trader UI system 102, for example, via a suitable local area network (LAN) or wide area network (WAN). In other examples, some network-enabled devices communicate indirectly. For example, a network-enabled device such as one or both of the biometric sensor devices 108, 110 may communicate with a second device, such as a user computing device 112, 114, via a short-range communication medium such as Bluetooth® or near field communication (NFC). The second device may act as a conduit passing received data to the trader UI system 102.

The various network-enabled devices 108, 110, 112, 114, 116, 118 may provide history data to the trader UI system 102. For example, the biometric sensor devices 108, 110 may provide the biometric history data 120. The biometric history data 120 may describe biometric properties of the trader 104 over time. Example biometric properties include breathing rate, heart rate, activities (e.g., steps walked), sleeping data (e.g., hours slept, sleeping patterns), skin impedance, etc.

The browsing history data 122 may include web pages, video, and/or other content provided to the trader 104. The appliance history data 124 may include, for example, appliance functions performed and, in some examples, data describing the appliance function. For example, a refrigerator with a camera may provide images captured when an appliance function is performed. The entertainment history data 126 may describe entertainment content (e.g., video, audio, etc.) provided to the trader 104.

The history data 120, 122, 124, 126, etc., in some examples, may be tagged or indexed in a manner describing the operation of the network-enabled devices 108, 110, 112, 114, 116, 118, etc. that captured or generated it. For example, entertainment history data 126 describing a television program may be tagged or indexed to indicate, for example, the name of the program, a genre of the program, etc. The browsing history data 122 may be tagged to indicate an address of viewed content, a topic of the viewed content, etc. The biometric history data 120 may be tagged to indicate the type of data captured, etc. The appliance history data 124 may be tagged to indicate, for example, the relevant appliance, the type of function performed, etc.

In some examples, some or all of the history data 120, 122, 124, 126, etc. is tagged with a timestamp or other indication of the time when the data was captured by the network-enabled devices 108, 110, 112, 114, 116, 118. For example, the biometric history data 120 may include timestamps indicating when various biometric signals were taken. The browsing history data 122 may include timestamps indicating when particular pages or other content was viewed. The appliance history data 124 may include timestamp data indicating when a particular appliance function was performed. The entertainment history data 126 may include timestamp data indicating when particular entertainment content was provided to the trader 104.

The trader UI system 102 may comprise a data aggregator subsystem 128, a security reference subsystem 130, and a UI generator subsystem 132. The data aggregator subsystem 128 may receive the history data 120, 122, 124, 126, etc. from various network-enabled devices. In some examples, the data aggregator subsystem 128 time-aligns the history data 120, 122, 124, 126, etc., for example, by standardizing timestamps added by the different network-enabled devices 108, 110, 112, 114, 116, 118. In some examples, the data aggregator subsystem 128 standardizes tags or other indices of the history data 120, 122, 124, 126, etc.

The security reference subsystem 130 may process received history data 120, 122, 124, 126, etc. to extract security reference data. Security reference data includes the history data 120, 122, 124, 126, etc. that references a security or market for securities. A reference to a security may include, for example, an indication of a company that is an issuer of a security, an indication of a product sold by a company that is an issuer of a security, etc. In some examples, the security reference subsystem 130 may also add tags or other indicators to the security reference data indicating, for example, tags from the associated history data 120, 122, 124, 126, etc., and/or tags indicating the security, securities, and/or markets that are referenced.

The security reference subsystem 130 may extract any suitable references to securities or markets. For example, the appliance history data 124 from a refrigerator may include an image of a food item removed from, added to, or in the refrigerator. Extracting security reference data may include identifying the food item and generating data describing the food item, including, for example, the company that manufactured the food item, competitors of that company, etc. Referring to the browsing history data 122, for example, the security reference subsystem 130 may identify the company indicated by advertisements appearing with particular content, a publisher of particular content, a company, market, etc. described by particular content, etc.

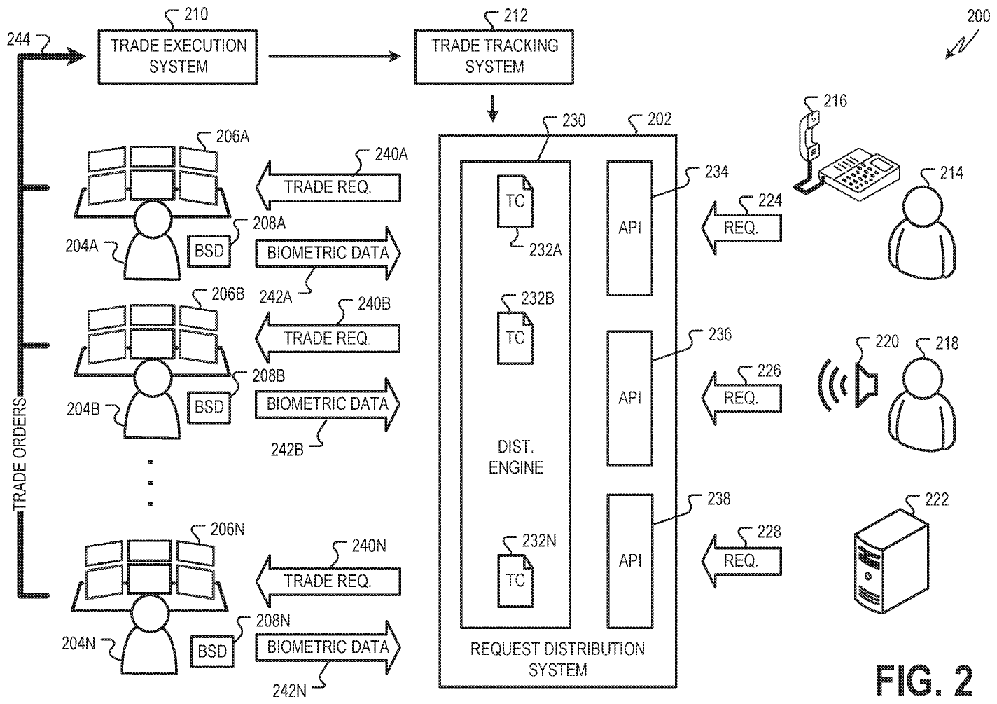

The UI generator subsystem 132 may generate the trader UI 129. For example, the UT generator subsystem 132 may populate the trader UI 12.9 with data, such as security reference data generated by the security reference subsystem 130 and/or other security and/or market data received from any suitable source. In some examples, the trader UI 129 may include data describing one or more trade requests 127. The trade requests 127 may describe a trade that the trader 104 is requested to perform. The trade requests 127 may be directed to the trader 104, for example, by a request distribution system 202 (FIG. 2).

FIG. 2 is a diagram showing one example of an environment 200 for distributing trade requests to traders based on feedback. The environment 200 includes a request distribution system 202, and various trader computing devices 206A, 206B, 206N for interfacing with various traders 204A, 204B, 204N. The request distribution system 202 receives trade requests from various sources 216, 220, 222 and distributes the trade requests to the various traders 204A, 204B, 204N, for example, based on trader criteria data 232A, 232B, 232N, as described herein.

The request distribution system 202 may be or include any suitable type of computing device, including, for example, a server, a laptop computer, a desktop computer, etc. The request distribution system 202 may be located at a single location or may include multiple networked computing devices spread across multiple geographic locations. The request distribution system 202 receives incoming trade requests 224, 226, 228 from various different sources and distributes outgoing trade requests 240A, 240B, 240N to the traders 204A, 204B, 204N via the trader computing devices 206A, 206B, 206N. The outgoing trade requests 240A, 240B, 240N may correspond to the incoming trade requests 224, 226, 228. For example, the incoming trade requests 224, 226, 228 may be forwarded to the traders 204A, 204B, 204N as the outgoing trade requests 240A, 240B, 240N, for example, as described herein.

The incoming trade requests 224, 226, 228 may be received from any suitable sources. Three example sources are shown in FIG. 2, but any suitable number of sources may be used. For example, some trade requests are received via a telephone 216. For example, a user 214, who may be a salesperson, receives a telephone call on the telephone 216 from a client requesting a particular trade. The user 214 generates the incoming trade request 224 that is provided to the request distribution system 202. In some examples, the user 214 enters the request via the telephone 216 or another suitable computing device. In some examples, the telephone 216 or another suitable computing device is programmed to execute a voice-to-text algorithm to convert a voice message received via the telephone 216 to the incoming trade request 224.

The incoming trade request 226 may be generated by a loudspeaker system 220 (sometimes called a “hooter”). A user 218 may announce a requested trade over the loudspeaker system 220. Other users (e.g., salespeople) may hear the requested trade and enter the incoming trade request 226 to the request distribution system 202. The user 218 may manually enter the incoming trade request 226. In some examples, the loudspeaker system 220 may include a processor unit to execute a voice-to-text algorithm to convert the verbal trade request to the incoming trade request 226 provided to the request distribution system 202.

The incoming trade request 228 may be generated by a trading server 222 or another suitable computing device. The trading server 222 may be or include any suitable computing device. The trading server 222, in some examples, is associated with a customer or client and may forward trades requested by personnel at the customer or client as some or all of the incoming trade request 228. In some examples, the trading server 222 automatically generates the incoming trade request 228, for example, as part of an algorithmic trading program, a stop-loss limit order, etc.

The request distribution system 202 may include one or more application programming interfaces (APIs) 234, 236; 238 for receiving the incoming trade requests 224, 226, 228. The APIs 234, 236, 238 may be configured to receive the incoming trade requests 224, 226, 228 and convert them to a format that can be processed by the request distribution system 202 (e.g., a distribution engine 230 thereof).

The distribution engine 230 may apply one or more sets of trader criteria data 232A, 232B, 232N to distribute trade requests, such as the incoming trade requests 224; 226; 228, to the traders 204A, 204B, 204N (e.g., via the trader computing devices 206A, 206B, 206N). For example, the trader 204A may have associated trader criteria data 232A; the trader 204B may have associated trader criteria data 232B; and the trader 204N may have associated trader criteria data 232N.

The trader criteria data 232A, 232B, 232N may describe trade requests that are to be provided to a particular trader 204A, 204B, 204N, for example, based on trade request properties such as notional value; lot size, lot type, curve portion, etc. Notional value describes the value of the security or securities involved in a trade. Different traders 204A, 204B, 204N may have different notional value limits or ranges indicated by the trader criteria data 232A, 232B, 232N. For example, some traders 204A, 204B, 204N may receive trade requests under a first value threshold, while other traders 204A, 204B, 204N may receive trade requests under a second value threshold greater than the first value threshold.

Lot size may describe the number of securities involved in a requested trade. For example, round lots include large numbers of securities to be purchased or sold. (Trades involving round lots are also called block trades.) Odd lots describe trade requests with smaller numbers of securities to be bought or sold. For example, an odd lot trade request may involve the purchase or sale of less than a full or round lot of securities. Because of the volume of securities involved, block trades can be more difficult to execute than trades with smaller numbers of securities. Curve portion is used, for example, in fixed-income securities, to describe the maturity of the bonds or other fixed-income security traded. For example, some traders may receive requests for trades in short-term bonds while other traders may receive requests for trades in longer-term bonds.

In some examples, the trader criteria data 232A, 232B, 232N may also describe conditions for providing trade requests to the traders 204A, 204B, 204N. For example, some traders 204A, 204B, 204N may have a stop-loss limit that prevents additional trade requests from being distributed to that trader if the trader has lost a threshold amount over a particular time period. The trader criteria data 232A, 232B, 232N, in some examples, may describe different trades to provide to the traders 204A, 204B, 204N at different times of the day. For example, some traders 204A, 204B, 204N may perform better on smaller notional trades in the morning, afternoon, etc.

The request distribution system 202 (e.g., the distribution engine 230) assigns the incoming trade requests 224, 226, 228 to the traders 204A, 204B, 204N by applying the trader criteria data 232A, 232B, 232N. For example, the outgoing trade requests 240A are provided to the trader 204A; the outgoing trade requests 240B are provided to the trader 204B; and the outgoing trade requests 240N are provided to the trader 204N.

The traders 204A, 204B, 204N may execute the outgoing trade requests 240A, 240B, 240N by making one or more trade orders 244 to a trade execution system 210. The trade execution system 210 may communicate with one or more exchanges, counterparties, etc. to execute ordered trades. A trade tracking system 212 may track the profit or loss on executed trades and report the same to the request distribution system 202. Profit and loss data may be provided to the distribution engine 230, for example, with trade result data.

The request distribution system 202 (e.g., the distribution engine 230) may receive biometric data 242A, 242B, 242N from the respective traders 204A, 204B, 204N. The biometric data 242A, 242B, 242N may be received from one or more biometric sensor devices 208A, 208B, 208N. The biometric sensor devices 208A, 208B, 208N may be similar to the biometric sensor devices 108, 110 described herein.

The request distribution system 202 (e.g., the distribution engine 230), in some examples, modifies the trader criteria data 232A, 232B, 232N in response to trade result data and/or the biometric data 242A, 242B, 242N. For example, the request distribution system 202 may detect that a trader 204A, 204B, 204N is experiencing a risk condition based on the biometric data 242A, 242B, 242N and/or trade result data. For example, a risk condition may occur when the biometric data 242A, 242B, 242N indicates that the trader 204A, 204B, 204N is experiencing a high level of stress (e.g., elevated blood pressure or heart rate, etc.). Also, for example, a risk condition may occur when trade result data indicates that the trader's 204A, 204B, 204N previous trades lost more than a threshold amount over a given number of trades, a given amount of time, etc. In some examples, a risk condition may occur based on a combination of trade result data and the biometric data 242A, 242B, 242N. For example, a trader 204A, 204B, 204N who has lost more than a threshold amount and is showing biometric data 242A, 242B, 242N indicating high stress levels may be in a risk condition.

In response to a risk condition, the request distribution system 202 (e.g., distribution engine 230) may modify the trader criteria data 232A, 232B, 232N for the affected trader 204A, 204B, 204N to pause the outgoing trade requests 240A, 240B, 240N provided to the trader 204A, 204B, 204N. In some examples, in response to a risk condition, the request distribution system 202 may modify the trader criteria data 232A, 232B, 232N to assign less challenging trade requests to the trader 204A, 204B, 204N (e.g., trades with smaller notional values, trades at less challenging positions on the yield curve, odd lot trades instead of block trades, etc.). A pause or change in request assignment in response to a risk condition may persist for a predetermined amount of time, until the biometric and/or trade result data indicates that the risk condition no longer exists, and/or until another set of biometric and/or trade result thresholds are met.

The environment 200 may be utilized alone or, in some examples, in conjunction with the environment 100 of FIG. 1. For example, the request distribution system 202 may be in communication with the trader UI system 102, for example, to receive the biometric history data 120, which may also serve as the biometric data 242A, 242B, 242N as described in FIG. 2. Also, in some examples, the outgoing trade requests 240A, 240B. 240N for the traders 204A, 204B, 204N may be provided to one or more examples of the trader UI system 102, which may incorporate the outgoing trade requests 240A, 240B, 240N into the trader UI 129.

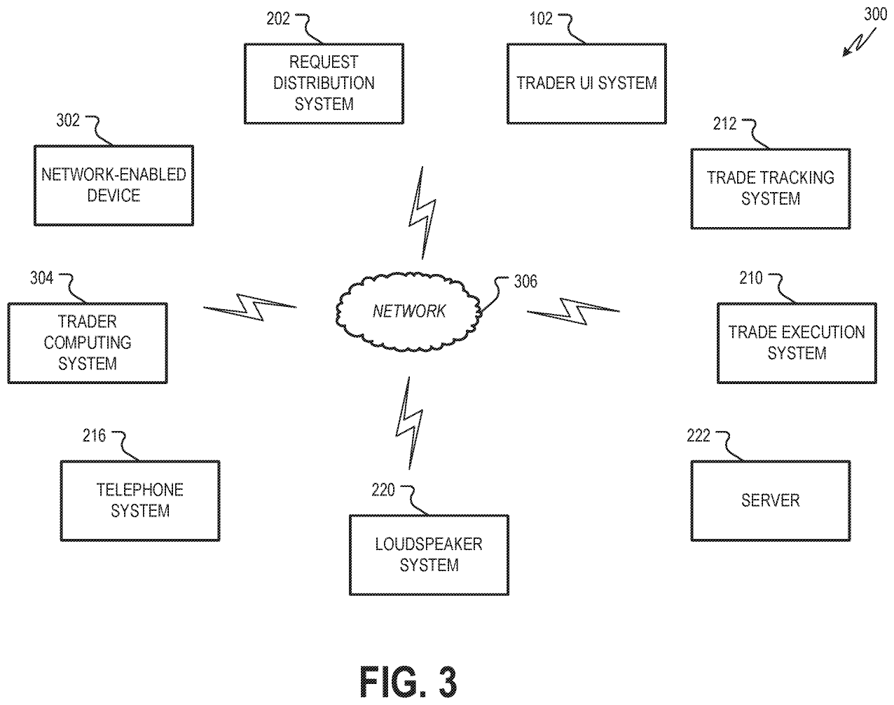

FIG. 3 is a diagram showing another example environment 300 including components of the environment 100 and the environment 200. For example, the environment 300 includes the trader UI system 102. A network-enabled device 302 may be or include any suitable network-enabled device, for example, similar to the network-enabled devices 108, 110, 112, 114, 116, 118 of FIG. 1 and/or the biometric sensor devices 208A, 208B, 208N of FIG. 2, A trader computing system 304 may be similar to the trader computing device 106 of FIG. 1 or the trader computing devices 206A, 206B, 206N of FIG. 2. The environment 300 also includes the request distribution system 202, trade execution system 210, trade tracking system 212, telephone 216, loudspeaker system 220, and trading server 222 of FIG. 2.

The various components of the environment 300 may be in communication with one another via a network 306, The network 306 may be or comprise any suitable network element operated according to any suitable network protocol. For example, one or more portions of network 306 may be an ad hoc network, an intranet, an extranet, a virtual private network (TN), a LAN, a wireless LAN (WLAN), a WAN, a wireless WAN (WWAN), a metropolitan area network (MAN), a portion of the Internet, a portion of the Public Switched Telephone Network (PSTN), a cellular telephone network, a wireless network, a Wi-Fi network, a WiMax network, another type of network, or a combination of two or more such networks.

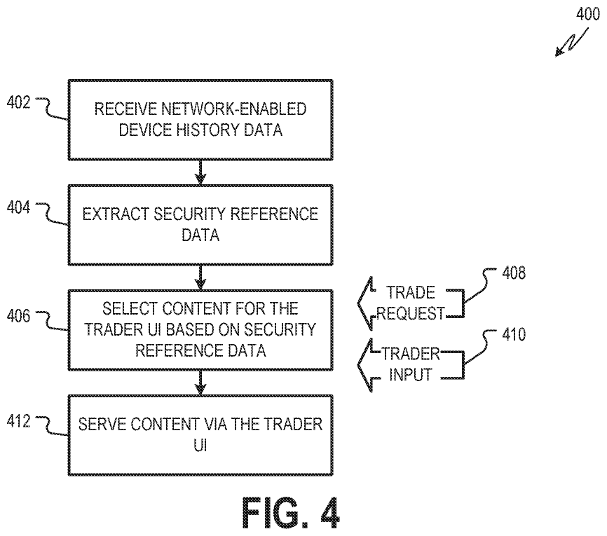

FIG. 4 is a flowchart showing one example of a process flow 400 that may be executed by the trader UI system 102 to generate and serve the trader UI 129 to the trader 104. At operation 402, the trader UI system 102 may receive network-enabled device history data. This may include any history data generated by a network-enabled device, such as, for example, the biometric history data 120, browsing history data 122, appliance history data 124, entertainment history data 126, etc. At operation 404, the trader UI system 102 (e.g., the security reference subsystem 130) may extract security reference data from the received history data.

At operation 406, the trader UI system 102 (e.g., the UI generator subsystem 132) may select content for the trader UI 129 based on the security reference data extracted at operation 404. In some examples, the content selected may also be based on trader input data 410 and/or a trade request 408. The trade request 408 may describe a trade that the trader 104 has been requested to execute. For example, the trader UI system 102 may select data describing securities included in the trade request 408 and/or markets for the securities. The trader input data 410 may include, for example, a request for a particular security. In some examples, the trader input data 410 may reference a tag, an index subject, a time that content or services were provided, etc. For example, the trader 104 may request information about the company referenced by a television show that the trader 104 watched the night before, or a web site that she browsed while having breakfast. In another example, the trader input data 410 may reference a use of an appliance (e.g., “Show me the brand of catsup that I placed in the refrigerator last night”).

In this way, the trader 104 may not need to remember the names of the markets, securities, or other topics about which the trader 104 would like to receive information. Instead, the trader 104 may only need to remember a tag, index subject, time of provision, etc. This may aid the trader's 104 memory and allow the trader 104 to access and utilize functionality of the trader UI system 102 that may not have been accessible if the trader 104 had to rely on memory alone to recall the proper name of the desired security, market data, etc. At operation 412, the trader UI system 102 may serve content selected at operation 406 to the trader 104, for example, via the trader computing device 106.

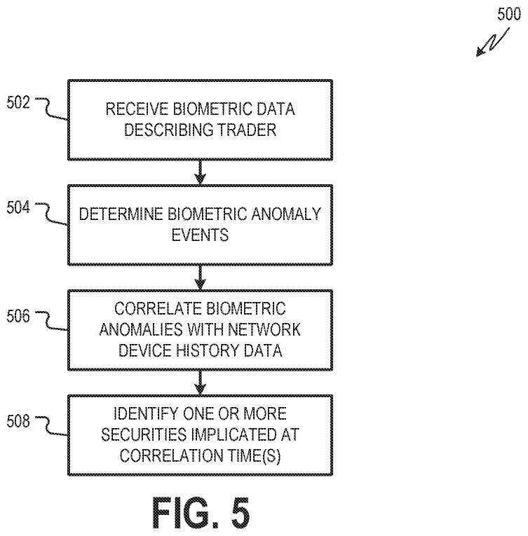

FIG. 5 is a flowchart showing one example of a process flow 500 that may be executed, for example, by the trader UI system 102 of FIG. 1 to extract security reference data from network-enabled device history data. For example, the process flow 500 shows one example way that the trader UI system 102 may execute operation 404 of the process flow 400 described above.

At operation 502, the trader LI system 102 may receive biometric data describing the trader 104. In some examples, the biometric data is part of the network-enabled device history data received from a networked device. For example, the biometric sensor device 108, 110 may provide the biometric history data 120 that includes biometric data describing the trader 104.

At operation 504, the trader UI system 102 (e.g., the security reference subsystem 130) may identify biometric anomalies in the biometric data. Biometric anomalies may occur when the trader's biometric data is outside of a normal range. The normal range may be determined in any suitable manner depending, for example, on a particular biometric property and/or the particular trader 104. Take, for example, the trader's heart rate. There may be a normal resting heart rate range for people of the trader's age, weight, etc. In some examples, the trader system 102 (or another system such as the biometric sensor device 108, 110) may monitor the trader's heart rate over time and determine a normal resting heart rate range for the specific trader 104. A biometric anomaly may be detected when the trader's heart rate is outside of the normal range. Biometric properties other than heart rate may similarly have normal ranges (e.g., general normal ranges and/or normal ranges specific to the trader 104). Biometric anomalies may be detected when a biometric property is outside of its normal range. Also, in some examples, biometric anomalies may be detected based on a combination of biometric properties.

At operation 506, the trader UI system 102 (e.g., the security reference subsystem 130) may correlate biometric anomalies with other network-enabled device history data. For example, the trader UI system 102 may use timestamps or other indications of time to determine how the trader 104 was interacting with other network-enabled devices at the time of the biometric anomaly. For example, the trader UI system 102 may identify other interactions between the trader 104 and network-enabled devices at the time of the biometric anomaly. At operation 508, the trader UI system 102 (e.g., the security reference subsystem 130) may identify one or more securities referenced by the other network-enabled device histories at the time of the biometric anomaly. This may be performed in any suitable manner. For example, if the trader 104 is watching a television program at the time of the biometric anomaly, the trader UI system 102 may identify one or more products (and/or companies) referenced by the television program. In another example, if the trader 104 is browsing a website at the time of the biometric anomaly, the trader UI system 102 may identify one or more products (and/or companies) referenced by the website. For example, when products are shown, securities issued by the company that produced the products may be identified. When a company is referenced, securities issued by that company may be identified.

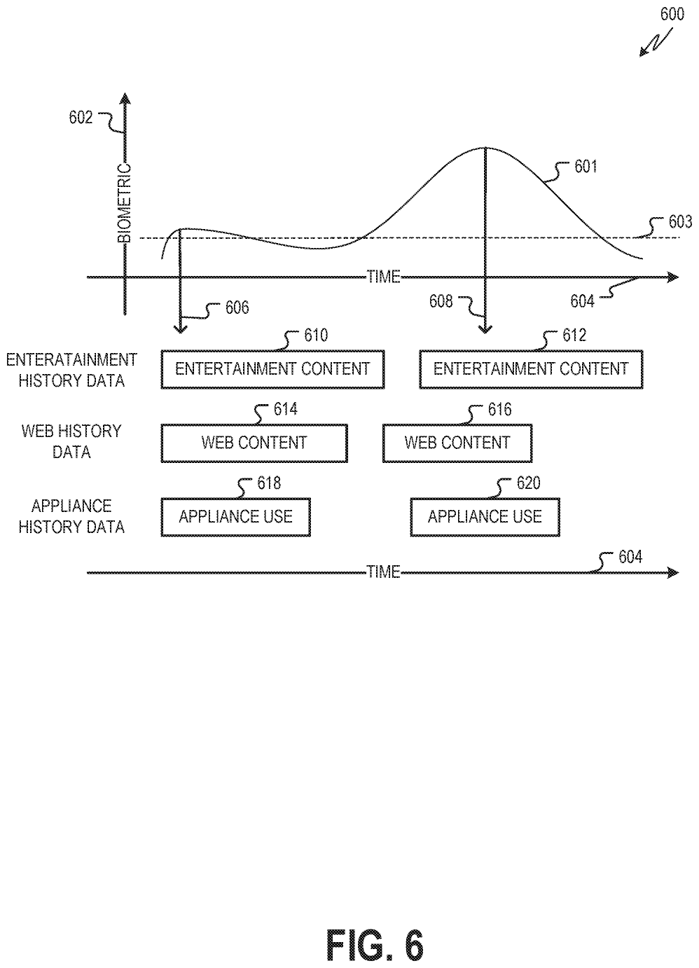

FIG. 6 is a timeline 600 showing an example correlation of biometric anomalies and other network-enabled device history data. A representation of a biometric property includes a vertical axis 602 indicating a value for the biometric property, a horizontal axis 604 indicating time, and a plot 601 indicating the value of the biometric property over time. The biometric property, indicated by the plot 601 may be any suitable biometric property, such as blood pressure, heart rate, breathing rate, activity rate (e.g., steps per minute), etc. A line 603 indicates a threshold value for the biometric property. For example, when the biometric property is above the line 603, it may be outside of the normal range.

The timeline 600 also shows various network-enabled device histories. For example, entertainment history data (such as the entertainment history data 126) shows two examples of entertainment content 610, 612. Browsing history data (such as the browsing history data 122) includes web content 614, 616. Appliance history data (such as the appliance history data 124) includes appliance uses 618, 620. The time at which the various network-enabled device histories occurred is shown on the horizontal axis 604, which is reproduced at the bottom of the timeline 600 for reference.

The timeline 600 shows two example biometric anomalies 606, 608, indicated as such because, at the biometric anomalies 606, 608, the value of the biometric property indicated by the plot 601 is above the threshold value line 603. Correlating the biometric anomalies 606, 608 to the other network-enabled device history data may include determining what content, use, etc. of the other network-enabled devices was occurring at the time of the biometric anomalies 606, 608. For example, during the first biometric anomaly 606, the trader 104 was viewing the entertainment content 610 and the web content 614 as well as performing the appliance use 618. The trader UI system 102 may select a portion of the content 610, 614 or use 618 that was occurring at or around the time of the biometric anomaly 606 and identify one or more securities that are directly or indirectly referenced. Similarly, the content 612, 616 and appliance use 620 may correlate to the biometric anomaly 608. The trader UI system 102 may select a portion of the content 612, 616 or use 620 that was occurring at or around the time of the biometric anomaly 608 and identify one or more securities that are directly or indirectly referenced.

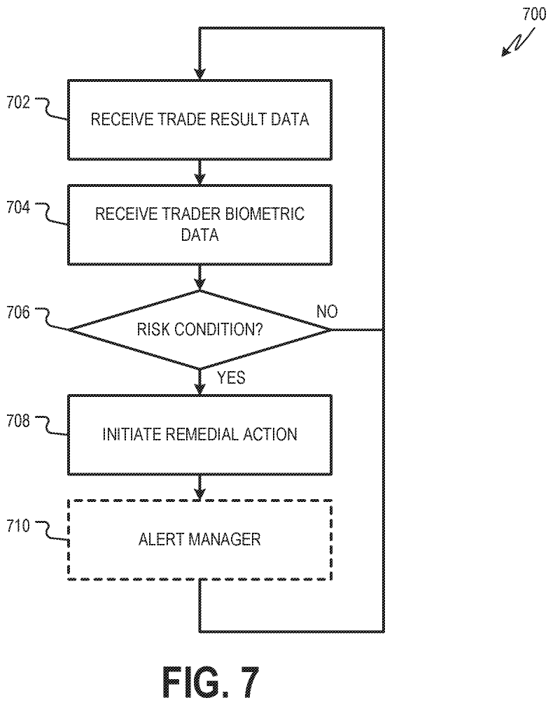

FIG. 7 is a flowchart showing one example of a process flow 700 that may be executed, for example, by the request distribution system 202 of FIG. 2 the distribution engine 230 thereof) to assign trade requests to traders 204A, 204B, 204N. At operation 702, the request distribution system 202 may receive trade result data, for example, from the trade tracking system 212. The trade result data may indicate the results of one or more trades executed by one or more of the traders 204A, 204B, 204N. The trade result data may indicate, for example, the profit or loss resulting from the trades, or any other metric indicating the success or failure of the trades. In some examples, the trade result data also indicates the trader 204A, 204B, 204N who executed particular trades.

At operation 704, the request distribution system 202 may receive trader biometric data 242A, 242B, 242N. The trader biometric data may indicate current or historical values for biometric properties describing the traders 204A, 204B, 204N. At operation 706, the request distribution system 202 may determine whether a risk condition exists for one or more of the traders 204A, 204B, 204N. Determining whether a risk condition exists may include considering the trade result data and the biometric data. A biometric anomaly, as described herein, may indicate a risk condition. For example, if the trader's heart rate is outside of a normal range, it may be an indication that a risk condition exists regardless of the trade result data. Also, in some examples, trade result data by itself may indicate a risk condition. For example, if the trader has executed a trade that has lost more than a threshold amount, the request distribution system 202 may determine that a risk condition exists regardless of the existence of a biometric anomaly. In some examples, the presence of a risk condition may depend on a combination of the biometric data and the trade result data. For example, a risk condition may be detected when a biometric anomaly occurs at or about the same time as one or more trades with losses above a loss threshold.

If a risk condition does not exist, the request distribution system 202 may return to operation 702 and continue to look for risk conditions. If a risk condition is detected, the request distribution system 202 may initiate a remedial action at operation 708. For example, the request distribution system 202 may modify the trader criteria data 232A, 232B 232N to change the types of outgoing trade requests 240A, 240B, 240N being provided to the trader 204A, 204B, 204N experiencing the risk condition.

In some examples, the trader criteria data 232A, 232B, 232N may be modified to change the type of trades being provided to the trader 204A, 204B, 204N. For example, a trader 204A, 204B, 204N who experiences a risk condition while receiving requests for round lot trades may subsequently, receive trade requests for odd lot trades (which may be easier to execute) for a predetermined time and/or until the risk condition abates. Also, for example, a trader 204A, 204B, 204N who experiences a risk condition while receiving requests for trades with high notional values may subsequently receive trade requests for lower notional value trades for a predetermined time (e.g., a cool-down period) and/or until the risk condition abates. Also, in some examples, a trader 204A, 204B, 204N experiencing a risk condition may not receive any trade requests for a predetermined time and/or until the risk condition abates.

At optional operation 710, the request distribution system 202 may send an alert message to a manager system. The manager system may be associated with another trader 204A, 204B, 204N or another user who manages the trader 204A, 204B, 204N experiencing the risk condition. The alert message may indicate the trader 204A, 204B, 204N experiencing the risk condition. In some examples, the alert message may also indicate the reason that the risk condition was detected (e.g., relevant biometric data, relevant trade result data, etc.) and/or the type of remedial action taken.

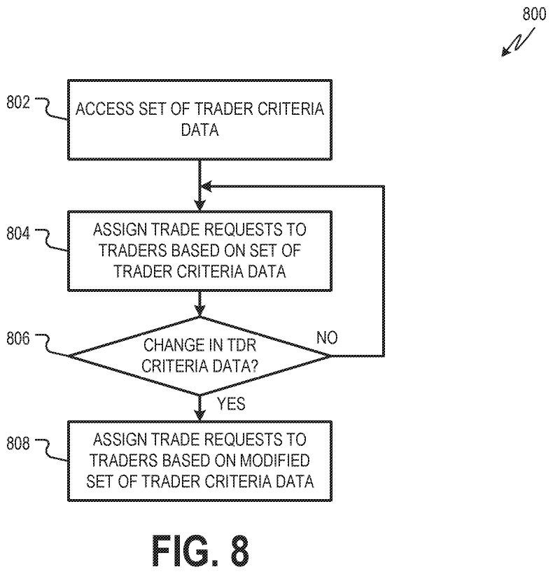

FIG. 8 is a flowchart showing one example of a process flow 800 that may be executed by the request distribution system 202 of FIG. 2 (e.g., the distribution engine 230 thereof) to distribute trade requests to traders 204A, 204B, 204N. At operation 802, the request distribution system 202 may access a set of trader criteria data 232A, 232B, 232N describing a set of traders 204A, 204B, 204N. At operation 804, the request distribution system 202 may assign trade requests to the set of traders 204A, 204B, 204N based on the set of trader criteria data 232A, 232B, 232N. For example, as incoming trade requests 224, 226, 228 come in to the request distribution system 202, the incoming trade requests 224, 226, 228 may be distributed according to the trader criteria data 232A, 232B, 232N.

At operation 806, the request distribution system 202 may determine if there has been a change to any trader criteria data 232A, 232B, 232N in the set of trader criteria data. If no change is determined, the request distribution system 202 may return to operation 804 and continue to assign the incoming trade requests 224, 226, 228 to the traders 204A, 204B, 204N according to the trader criteria data 232A, 232B, 232N. If, at operation 806, there has been a change in the trader criteria data 232A, 232B, 232N, the request distribution system 202 may, at operation 808, assign the incoming trade requests 224, 226, 228 according to the modified trader criteria data 232A, 232B, 232N. The trader criteria data 232A, 232B, 232N may have been modified, for example, in response to detection of a risk condition for one or more of the traders 204A, 204B, 204N, for example, as described herein with respect to FIG. 7.

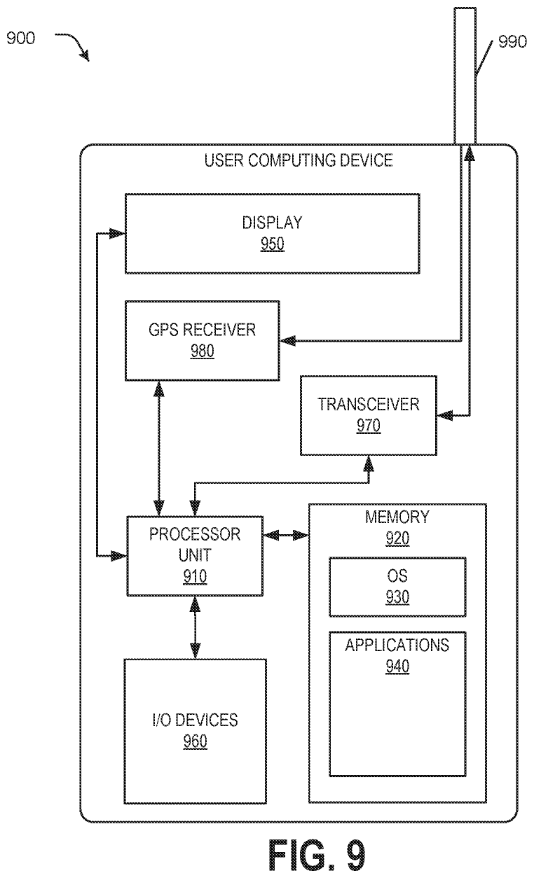

FIG. 9 is a block diagram showing an example architecture 900 of a user computing device. The architecture 900 may, for example, describe any of the computing devices described herein, including, for example, any of the network-enabled devices described herein. The architecture 900 comprises a processor unit 910. The processor unit 910 may include one or more processors. Any of a variety of different types of commercially available processors suitable for user computing devices may be used (for example, an XScale architecture microprocessor, a Microprocessor without Interlocked Pipeline Stages (MIPS) architecture processor, or another type of processor). A memory 920, such as a Random Access Memory (RAM), a flash memory, or another type of memory or data storage, is typically accessible to the processor. The memory 920 may be adapted to store an operating system (OS) 930, as well as application programs 940.

The processor unit 910 may be coupled, either directly or via appropriate intermediary hardware, to a display 950 and to one or more input/output (I/O′ devices 960, such as a keypad, a touch panel sensor, a microphone, and the like. Such I/O devices 960 may include a touch sensor for capturing fingerprint data, a camera for capturing one or more images of the user, a retinal scanner, or any other suitable devices. Similarly, in some examples, the processor unit 910 may be coupled to a transceiver 970 that interfaces with an antenna 990. The transceiver 970 may be configured to both transmit and receive cellular network signals, wireless data signals, or other types of signals via the antenna 990, depending on the nature of the user computing device implemented by the architecture 900. Although one transceiver 970 is shown, in some examples, the architecture 900 includes additional transceivers. For example, a wireless transceiver may be utilized to communicate according to an IEEE 802.11 specification, such as Wi-Fi and/or a short-range communication medium. Some short-range communication mediums, such as NFC, may utilize a separate, dedicated transceiver. Further, in some configurations, a Global Positioning System (GPS) receiver 980 may also make use of the antenna 990 to receive GPS signals. In addition to or instead of the GPS receiver 980, any suitable location-determining sensor may be included and/or used, including, for example, a Wi-Fi positioning system. In some examples, the architecture 900 (e.g., processor unit 910) may also support a hardware interrupt. In response to a hardware interrupt, the processor unit 910 may pause its processing and execute an interrupt service routine (ISR).

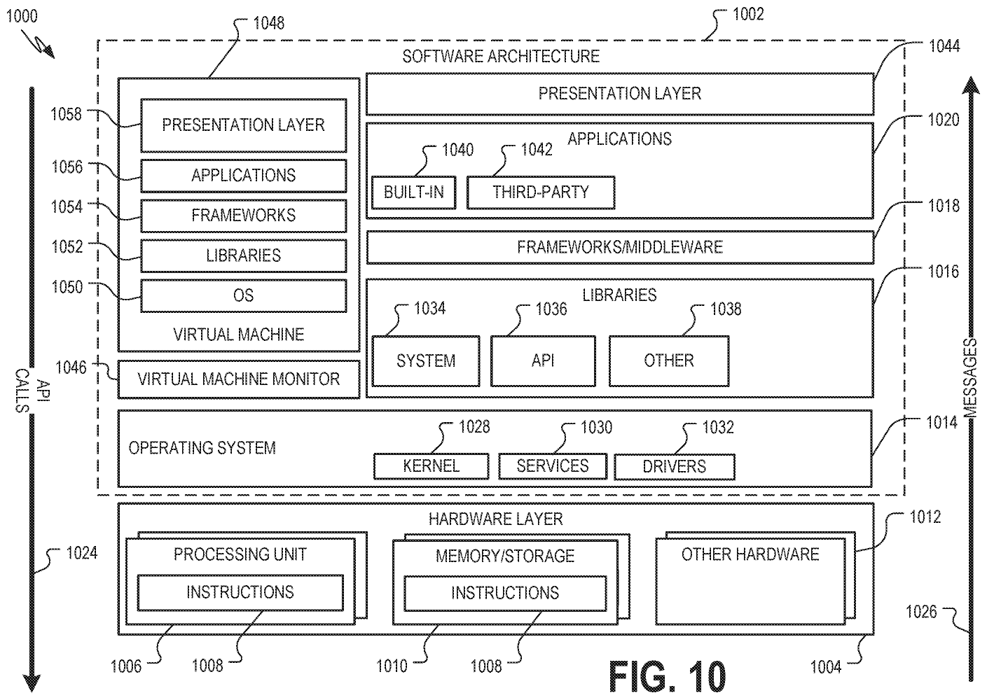

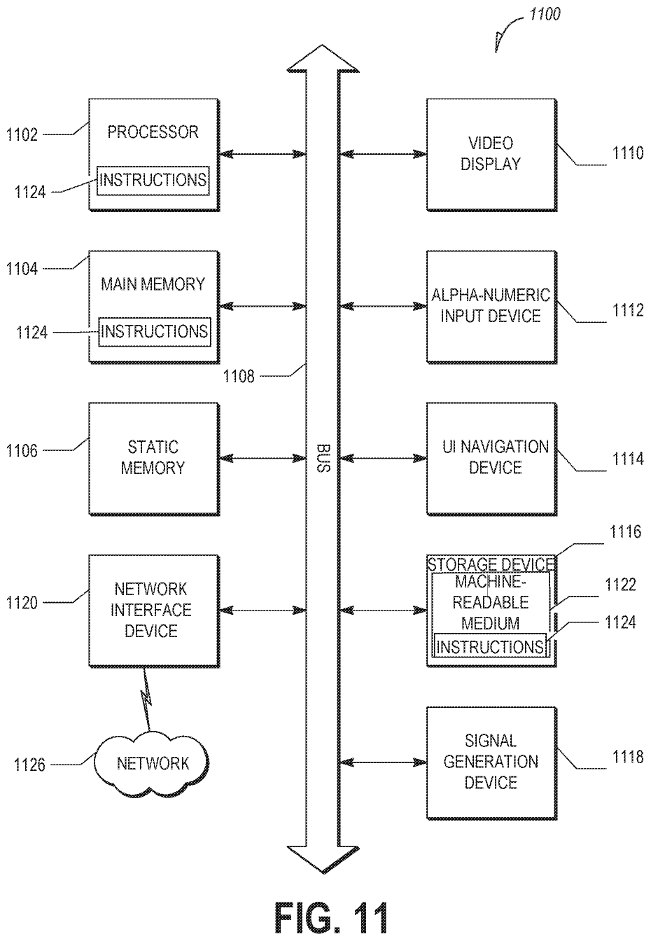

FIG. 10 is a block diagram 1000 showing one example of a software architecture 1002 for a computing device. The software architecture 1002 may be used in conjunction with various hardware architectures, for example, as described herein. FIG. 10 is merely a non-limiting example of a software architecture 1002 and many other architectures may be implemented to facilitate the functionality described herein. A representative hardware layer 1004 is illustrated and can represent, for example, any of the above-referenced computing devices. In some examples, the hardware layer 1004 may be implemented according to an architecture 1100 of FIG. 11 and/or architecture 900 of FIG. 9.

The representative hardware layer 1004 comprises one or more processing units 1006 having associated executable instructions 1008. The executable instructions 1008 represent the executable instructions of the software architecture 1002, including implementation of the methods, modules, components, and so forth of FIGS. 1-8. The hardware layer 1004 also includes memory and/or storage modules 1010, which also have the executable instructions 1008. The hardware layer 1004 may also comprise other hardware 1012, which represents any other hardware of the hardware layer 1004, such as the other hardware illustrated as part of the architecture 1100.

In the example architecture of FIG. 10, the software architecture 1002 may be conceptualized as a stack of layers where each layer provides particular functionality. For example, the software architecture 1002 may include layers such as an operating system 1014, libraries 1016, frameworks/middleware 1018, applications 1020, and a presentation layer 1044. Operationally, the applications 1020 and/or other components within the layers may invoke API calls 1024 through the software stack and receive a response, returned values, and so forth illustrated as messages 1026 in response to the API calls 1024. The layers illustrated are representative in nature and not all software architectures have all layers. For example, some mobile or special-purpose operating systems may not provide a frameworks/middleware 1018 layer, while others may provide such a layer. Other software architectures may include additional or different layers.

The operating system 1014 may manage hardware resources and provide common services. The operating system 1014 may include, for example, a kernel 1028, services 1030, and drivers 1032. The kernel 1028 may act as an abstraction layer between the hardware and the other software layers. For example, the kernel 1028 may be responsible for memory management, processor management (e.g., scheduling), component management, networking, security settings, and so on. The services 1030 may provide other common services for the other software layers. In some examples, the services 1030 include an interrupt service. The interrupt service may detect the receipt of a hardware or software interrupt and, in response, cause the software architecture 1002 to pause its current processing and execute an ISR when an interrupt is received. The ISR may generate an alert.

The drivers 1032 may be responsible for controlling or interfacing with the underlying hardware. For instance, the drivers 1032 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 1016 may provide a common infrastructure that may be utilized by the applications 1020 and/or other components and/or layers. The libraries 1016 typically provide functionality that allows other software modules to perform tasks in an easier fashion than by interfacing directly with the underlying operating system 1014 functionality (e.g., kernel 1028, services 1030, and/or drivers 1032). The libraries 1016 may include system libraries 1034 (e.g., C standard library) that may provide functions such as memory allocation functions, string manipulation functions, mathematic functions, and the like. In addition, the libraries 1016 may include API libraries 1036 such as media libraries (e.g., libraries to support presentation and manipulation of various media formats such as MPEG4, H.264, MP3, AAC, AMR, PG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 1016 may also include a wide variety of other libraries 1038 to provide many other APIs to the applications 1020 and other software components/modules.

The frameworks 1018 (also sometimes referred to as middleware) may provide a higher-level common infrastructure that may be utilized by the applications 1020 and/or other software components/modules. For example, the frameworks 1018 may provide various graphical user interface (GUI) functions, high-level resource management, high-level location services, and so forth. The frameworks 1018 may provide a broad spectrum of other APIs that may be utilized by the applications 1020 and/or other software components/modules, some of which may be specific to a particular operating system or platform.

The applications 1020 include built-in applications 1040 and/or third-party applications 1042. Examples of representative built-in applications 1040 may include, but are not limited to, a contacts application, a browser application, a book reader application, a location application, a media application, a messaging application, and/or a game application. The third-party applications 1042 may include any of the built-in applications 1040 as well as a broad assortment of other applications. In a specific example, the third-party application 1042 (e.g., an application developed using the Android™ or iOS™ software development kit (SDK) by an entity other than the vendor of the particular platform) may be mobile software running on a mobile operating system such as iOS™, Android™, Windows® Phone, or other user computing device operating systems. In this example, the third-party application 1042 may invoke the API calls 1024 provided by the mobile operating system such as the operating system 1014 to facilitate functionality described herein.

The applications 1020 may utilize built-in operating system functions (e.g., kernel 1028, services 1030, and/or drivers 1032), libraries (e.g., system libraries 1034, API libraries 1036, and other libraries 1038), or frameworks/middleware 1018 to create user interfaces to interact with users of the system. Alternatively, or additionally, in some systems, interactions with a user may occur through a presentation layer, such as the presentation layer 1044. In these systems, the application/module “logic” can be separated from the aspects of the application/module that interact with a user.

Some software architectures utilize virtual machines. For example, systems described herein may be executed utilizing one or more virtual machines executed at one or more server computing machines. In the example of FIG. 10, this is illustrated by a virtual machine 1048. A virtual machine creates a software environment where applications/modules can execute as if they were executing on a hardware computing device. A virtual machine is hosted by a host operating system (e.g., operating system 1014) and typically, although not always, has a virtual machine monitor 1046, which manages the operation of the virtual machine 1048 as well as the interface with the host operating system (e.g., operating system 1014). A software architecture executes within the virtual machine 1048, such as an operating system 1050, libraries 1052, frameworks/middleware 1054, applications 1056, and/or a presentation layer 1058. These layers of software architecture executing within the virtual machine 1048 can be the same as corresponding layers previously described or may be different.

FIG. 11 is a block diagram illustrating a computing device hardware architecture 1100, within which a set or sequence of instructions can be executed to cause a machine to perform examples of any one of the methodologies discussed herein. The architecture 1100 may describe, for example, any of the network-enabled devices herein as well as, for example, the trader UI system 102, request distribution system 202, trader computing devices 106, 206A, 206B, 206N, etc.

The architecture 1100 may execute the software architecture 1002 described with respect to FIG. 10, The architecture 1100 may operate as a standalone device or may be connected (e.g., networked) to other machines. In a networked deployment, the architecture 1100 may operate in the capacity of either a server or a client machine in server-client network environments, or it may act as a peer machine in peer-to-peer (or distributed) network environments. The architecture 1100 can be implemented in a personal computer (PC), a tablet PC, a hybrid tablet, a set-top box (STB), a personal digital assistant (PDA), a mobile telephone, a web appliance, a network router, a network switch, a network bridge, or any machine capable of executing instructions (sequential or otherwise) that specify operations to be taken by that machine.

The example architecture 1100 includes a processor unit 1102 comprising at least one processor (e.g., a central processing unit (CPU), a graphics processing unit (GPU), or both, processor cores, compute nodes, etc.). The architecture 1100 may further comprise a main memory 1104 and a static memory 1106, which communicate with each other via a link 1108 (e.g., bus). The architecture 1100 can further include a video display unit 1110, an alphanumeric input device 1112 (e.g., a keyboard), and a UI navigation device 1114 (e.g., a mouse), In some examples, the video display unit 1110, alphanumeric input device 1112, and UI navigation device 1114 are incorporated into a touchscreen display. The architecture 1100 may additionally include a storage device 1116 (e.g., a drive unit), a signal generation device 1118 (e.g., a speaker), a network interface device 1120, and one or more sensors (not shown), such as a GPS sensor, compass, accelerometer, or other sensor.

In some examples, the processor unit 1102 or another suitable hardware component may support a hardware interrupt. In response to a hardware interrupt, the processor unit 1102 may pause its processing and execute an for example, as described herein.

The storage device 1116 includes a machine-readable medium 1122 on which is stored one or more sets of data structures and instructions 1124 (e.g., software) embodying or utilized by any one or more of the methodologies or functions described herein. The instructions 1124 can also reside, completely or at least partially, within the main memory 1104, within the static memory 1106, and/or within the processor unit 1102 during execution thereof by the architecture 1100, with the main memory 1104, the static memory 1106, and the processor unit 1102 also constituting machine-readable media. The instructions 1124 stored at the machine-readable medium 1122 may include, for example, instructions for implementing the software architecture 1002, instructions for executing any of the features described herein, etc.

While the machine-readable medium 1122 is illustrated in an example to be a single medium, the term “machine-readable medium” can include a single medium or multiple media (e.g., a centralized or distributed database, and/or associated caches and servers) that store the one or more instructions 1124. The term “machine-readable medium” shall also be taken to include any tangible medium that is capable of storing, encoding, or carrying instructions for execution by the machine and that cause the machine to perform any one or more of the methodologies of the present disclosure, or that is capable of storing, encoding, or carrying data structures utilized by or associated with such instructions. The term “machine-readable medium” shall accordingly be taken to include, but not be limited to, solid-state memories, and optical and magnetic media. Specific examples of machine-readable media include non-volatile memory, including, but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 1124 can further be transmitted or received over a communications network 1126 using a transmission medium via the network interface device 1120 utilizing any one of a number of well-known transfer protocols (e.g.; hypertext transfer protocol (HTTP)). Examples of communication networks include a LAN, a WAN, the Internet, mobile telephone networks, plain old telephone service (POTS) networks, and wireless data networks (e.g., Wi-Fi, 3G, and 5G LTE/LTE-A or WiMAX networks). The term “transmission medium” shall be taken to include any intangible medium that is capable of storing; encoding, or carrying instructions for execution by the machine, and includes digital or analog communications signals or other intangible media to facilitate communication of such software.

Various components are described in the present disclosure as being configured in a particular way. A component may be configured in any suitable manner. For example, a component that is or that includes a computing device may be configured with suitable software instructions that program the computing device. A component may also be configured by virtue of its hardware arrangement or in any other suitable manner.

The above description is intended to be illustrative, and not restrictive. For example, the above-described examples (or one or more aspects thereof) can (be used in combination with others. Other embodiments can be used, such as by one of ordinary skill in the art upon reviewing the above description. The Abstract is to allow the reader to quickly ascertain the nature of the technical disclosure, for example, to comply with 37 C.F.R. § 1.72(b) in the United States of America. It is submitted with the understanding that it will not be used to interpret or limit the scope or meaning of the claims.

Also, in the above Detailed Description, various features can be grouped together to streamline the disclosure. However, the claims cannot set forth every feature disclosed herein, as embodiments can feature a subset of said features. Further, embodiments can include fewer features than those disclosed in a particular example. Thus, the following claims are hereby incorporated into the Detailed Description, with each claim standing on its own as a separate embodiment. The scope of the embodiments disclosed herein is to be determined with reference to the appended claims, along with the full scope of equivalents to which such claims are entitled.

1. A trader system for providing a user interface to a trader, the system comprising at least one processor unit and a machine readable medium in communication with the at least one processor unit, wherein the machine readable medium comprises instructions thereon that, when executed by the at least one processor unit, causes the at least one processor unit to execute operations comprising:
receiving entertainment history data from an entertainment system of the trader, the entertainment history data describing first entertainment content provided to the trader and comprising entertainment timestamp data indicating when the first entertainment content was provided to the trader;
receiving home appliance history data from a network-enabled home appliance of the trader, the home appliance history data comprising use data describing a use of the network-enabled home appliance by the trader, and home appliance timestamp data describing when the use occurred;
receiving trader biometric history data from a biometric sensor device, the trader biometric history data comprising biometric timestamp data comprising at least one biometric timestamp;
generating time-aligned history data using the entertainment timestamp data, the home appliance timestamp data, and the biometric timestamp data, the time-aligned history data relating the entertainment timestamp data, the home appliance timestamp data, and the biometric timestamp data to a common time;
identifying a first biometric anomaly at a first time using the time-aligned history data;
extracting first security reference data from the entertainment history data at the first time of the first biometric anomaly, the extracting of the first security reference data comprising determining a product indicated by the first security reference data at the first time; and determining a security associated with the product;
extracting second security reference data from the home appliance history data at the first time of the first biometric anomaly, the second security reference data being different than the first security reference data, the extracting of the second security reference data comprising: accessing an image associated with a use of the network-enabled home appliance by the trader at the first time, the second security reference data being based at least in part on the image;
selecting first content for a trader user interface based at least in part on the first security reference data and the second security reference data;
serving the trader user interface to a trader computing device;
determining that the first biometric anomaly indicates a trader risk condition;
responsive to determining that the first biometric anomaly indicates a trader risk condition, modifying trader criteria data to generate modified trader criteria data; and
assigning at least one trade to the trader based at least in part on the modified trader criteria data.

2. (canceled)

3. The system of claim 1, wherein the at least one processor unit is further programmed to execute operations comprising:
identifying a second biometric anomaly at a second time based at least in part on the trader biometric history data;
extracting third security reference data from at least one of the entertainment history data and the home appliance history data at the second time of the second biometric anomaly; and
selecting second content for the trader user interface based at least in part on the third security reference data.

4. The system of claim 1, wherein the at least one processor unit is further programmed to execute operations comprising:
receiving trader input data from the trader referencing the first entertainment content provided to the trader by the entertainment system; and
selecting the first security reference data based at least in part on the trader input data.

5. The system of claim 1, wherein the at least one processor unit is further programmed to execute operations comprising receiving trader input data from the trader referencing the network-enabled home appliance, wherein the extracting of the first security reference data is based at least in part on the trader input data.

6. (canceled)

7. A method of providing a user interface to a trader, the method comprising:
receiving, by a trader user interface (UI) system including a processor unit, entertainment history data from an entertainment system of the trader, the entertainment history data describing first entertainment content provided to the trader, and comprising entertainment timestamp data indicating when the first entertainment content was provided to the trader;
receiving, by the trader UI system, home appliance history data from a network-enabled home appliance of the trader, the home appliance history data comprising use data describing a use of the network-enabled home appliance by the trader, and home appliance timestamp data describing when the use occurred;
receiving, by the trader UI system, trader biometric history data from a biometric sensor device, the trader biometric history data comprising biometric timestamp data comprising at least one biometric timestamp;
generating time-aligned history data using the entertainment timestamp data, the home appliance timestamp data, and the biometric timestamp data, the time-aligned history data relating the entertainment timestamp data, the home appliance timestamp data, and the biometric timestamp data to a common time;
identifying a first biometric anomaly at a first time using the time-aligned history data;
extracting, by the trader UI system, first security reference data from the entertainment history data at the first time of the first biometric anomaly the extracting of the first security reference data comprising determining a product indicated by the first security reference data at the first time; and determining a security associated with the product;
extracting second security reference data from the home appliance history data at the first e of the first biometric anomaly, the second security reference data being different than the first security reference data, the extracting of the second security reference data comprising: accessing an image associated with a use of the network-enabled home appliance by the trader at the first time, the second security reference data being based at least in part on the image:
selecting, by the trader UT system, first content for a trader user interface based at east in part on the first security reference data and the second security reference data;
serving, by the trader UI system, the trader user interface to a trader computing device;
determining that the first biometric anomaly indicates a trader risk condition;
responsive to determining that the first biometric anomaly indicates a trader risk condition, modifying trader criteria data to generate modified trader criteria data; and
assigning at least one trade to the trader based at least in part on the modified trader criteria data.

8. (canceled)

9. The method of claim 7, further comprising:
identifying a second biometric anomaly at a second time based at least in part on the trader biometric history data;
extracting third security reference data from at least one of the entertainment history data and the home appliance history data at the second time of the second biometric anomaly; and
selecting second content for the trader user interface based at least in part on the third security reference data.

10. The method of claim 7, further comprising:
receiving, by the trader UI system, trader input data from the trader referencing the first entertainment content provided to the trader by the entertainment system; and
selecting, by the trader UI system, the first security reference data based at least in part on the trader input data.

11. The method of claim 7, further comprising receiving, by the trader UI system, trader input data from the trader referencing the network-enabled home appliance, wherein the extracting of the first security reference data is based at least in part on the trader input data.

12-20. (canceled)

21. A tangible machine-readable medium having instructions thereon that, when executed by at least one processor unit, causes the at least one processor unit to execute operations comprising:
receiving entertainment history data from an entertainment system of a trader, the entertainment history data describing first entertainment content provided to the trader, and comprising entertainment timestamp data indicating when the first entertainment content was provided to the trader;
receiving home appliance history data from a network-enabled home appliance of the trader, the home appliance history data comprising use data describing a use of the network-enabled home appliance by the trader, and home appliance timestamp data describing when the use occurred;
receiving trader biometric history data from a biometric sensor device, the trader biometric history data comprising biometric timestamp data comprising at least one biometric timestamp;
generating time-aligned history data using the entertainment timestamp data, the home appliance timestamp data, and the biometric timestamp data, the time-aligned history data relating the entertainment timestamp data, the home appliance timestamp data, and the biometric timestamp data to a common time;
identifying a first biometric anomaly at a first time using the time-aligned history data;
extracting first security reference data from the entertainment history data at the first time of the first biometric anomaly, the extracting of the first security reference data comprising determining a product indicated by the first security reference data at the first time; and determining a security associated with the product;
extracting second security reference data from the home appliance history data at the first time of the first biometric anomaly, the second security reference data being different than the first security reference data, the extracting of the second security reference data comprising: accessing an image associated with a use of the network-enabled home appliance by the trader at the first time, the second security reference data being based at least in part on the image;
selecting first content for a trader user interface based at least in part on the first security reference data and the second security reference data;
serving the trader user interface to a trader computing device;
determining that the first biometric anomaly indicates a trader risk condition;
responsive to determining that the first biometric anomaly indicates a trader risk condition, modifying trader criteria data to generate modified trader criteria data; and
assigning at least one trade to the trader based at least in part on the modified trader criteria data.

22. (canceled)

23. The medium of claim 21, the operations further comprising:
identifying a second biometric anomaly at a second time based at least in part on the trader biometric history data;
extracting third security reference data from at least one of the entertainment history data and the appliance history data at the second time of the second biometric anomaly; and
selecting second content for the trader user interface based at least in part on the third security reference data.

24. The medium of claim 21, the operations further comprising:
receiving trader input data from the trader referencing the entertainment provided to the trader by the entertainment system; and
selecting the first security reference data based at least in part on the trader input data.

25. The medium of claim 21, the operations further comprising
receiving trader input data from the trader referencing the network-enabled home appliance, wherein the extracting of the first security reference data is based at least in part on the trader input data.

26. (canceled)
